(19) United States
(12) Patent Application Publication
(10) Pub. No.: US 2009/0043056 A1
(43) Pub. Date: Feb. 12, 2009

(54) Process for the Preparation of an Improved Double Metal Cyanide Complex Catalyst, Double Metal Cyanide Catalyst and Use of Such Catalyst

(76) Inventors: Michiel Barend Eleveld, Amsterdam (NL); Peter Alexander Schut, Amsterdam (NL)

Correspondence Address: SHELL OIL COMPANY, P O BOX 2463, HOUSTON, TX, 772522463, US

(21) Appl. No.: 11/886,796

(22) PCT Filed: Mar. 20, 2006
(86) PCT No.: PCT/EP2006/060872

§ 371 Date: Sep. 20, 2007

(30) Foreign Application Priority Data
Mar. 22, 2005 (EP) 05102314.1

(51) Int. Cl. C08F 4/70; C01B 21/00

(52) U.S. Cl. 526/117; 423/364

(57) ABSTRACT

Process for the preparation of a double metal cyanide (DMC) catalyst comprising a) preparation of a DMC catalyst; b) dispersing the catalyst of step a) in a dispersion agent, yielding a catalyst dispersion; c) allowing sedimentation of part of the catalyst from the catalyst dispersion obtained in step b), yielding a sedimentated catalyst and a dispersed catalyst; d) separating the dispersed catalyst from the sedimentated catalyst.

### FIELD OF THE INVENTION

The present invention relates to a process for the preparation of a double metal cyanide catalyst; a catalyst, which is obtainable with such a process; and a process wherein such a catalyst can be used.

### BACKGROUND OF THE INVENTION

Double metal cyanide (DMC) catalysts are well known for polymerizing alkylene oxides like propylene oxide and ethylene oxide to prepare poly(alkylene oxide) polymers, also referred to as polyether polyols. Besides for the preparation of polyether polyols the catalysts can be used to make a variety of polymer products, including polyester polyols and polyetherester polyols. The polyols can be used for preparing polyurethanes by reacting them with poiyisocyanates under appropriate conditions. Poly urethane products that can be made include polyurethane coatings, elastomers, sealants, foams, and adhesives.

The DMC catalysts are highly active, and give polyether polyols that have low unsaturation compared with similar polyols made using strong basic catalysts such as potassium hydroxide.

Catalysts with improved activity are, however, still desirable because this enables the use of reduced catalyst levels.

WO-A-97/26080 describes a process for the preparation of a paste of double metal cyanide compound, an organic complexing agent and water, wherein the paste comprises at least about 90 wt % of particles having a particle size within the range of about 0.1 to about 10 microns. Such a paste, is however, difficult to transport and handle in a process.

U.S. Pat. No. 5,900,384 describes a process for the preparation of a double metal cyanide complex catalyst comprising the preparation of a slurry of double metal cyanide complex catalyst particles and drying said particles by spray drying. This method is, however, cumbersome and energy intensive and consequently costly.

It would be advantageous to have an improved process for the preparation of an improved double metal cyanide (DMC) comprising catalyst.

### SUMMARY OF THE INVENTION

Accordingly the present invention provides a process for the preparation of a double metal cyanide (DMC) catalyst comprising

a) preparation of a DMC catalyst;
b) dispersing the catalyst of step a) in a dispersion agent, yielding a catalyst dispersion;
c) allowing sedimentation of part of the catalyst from the catalyst dispersion obtained in step b), yielding a sedimentated catalyst and a dispersed catalyst;
d) separating the dispersed catalyst from the sedimentated catalyst.

It has been found that the catalyst prepared according to the present invention is highly active.

In addition, the process of the present invention allows one to reduce the particle size of a DMC catalyst whilst the amorphous or crystalline structure of such DMC catalyst is maintained.

In addition the present invention provides a catalyst obtainable by such a process and a process for use of such a catalyst.

### FIGURES OF THE INVENTION

The invention is illustrated with the following figures:

FIG. 1: X-ray diffraction spectrum of a DMC catalyst

FIG. 2a: Particle size distribution of a catalyst A not according to the invention

FIG. 2b: Particle size distribution of a catalyst B according to the invention

### DETAILED DESCRIPTION OF THE INVENTION

Step a) of the process according to the invention may be carried out in any manner known to the skilled person to be suitable for this purpose. DMC catalysts can be prepared by reacting aqueous solutions of metal salts and metal cyanide salts to form a precipitate of the DMC compound. Preferably the catalysts are prepared in the presence of an organic complexing agent. Examples of such organic complexing agents include ethers such as glyme (dimethoxy-ethane) or diglyme and alcohols, such as iso-propyl-alcohol or tert-butyl alcohol. The complexing agent favourably impacts the activity of the catalyst for epoxide polymerization. Other known complexing agents include ketones, esters, amides and ureas. Processes for the preparation of double metal cyanide catalysts are for example given in EP-A-654302 and WO-01/72418.

The DMC catalyst can for example be obtained by

i) combining an aqueous solution of a metal salt with an aqueous solution of a metal cyanide salt and reacting these solution wherein at least part of this reaction takes place in the presence of an organic complexing agent, thereby forming a dispersion of a solid DMC complex in an aqueous medium;
ii) combining the dispersion obtained in step (i) with a liquid, which is essentially insoluble in water and which is capable of extracting the solid DMC complex allowing a two-phase system to be formed consisting of a first aqueous layer and a layer containing the DMC complex and the liquid added;
iii) removing the first aqueous layer; and
iv) recovering the DMC catalyst from the layer containing the DMC catalyst.

The catalyst might also be prepared by

i) intimately combining and reacting an aqueous solution of a water-soluble metal salt and an aqueous solution of a water-soluble metal cyanide salt in the present of an organic complexing agent, to obtain an aqueous mixture that contains a precipitated DMC catalyst;
ii) isolating and drying the catalyst obtained in step i).

The above processes are explained in more detail in EP-A-654302 and WO-01/72418, which are hereby incorporated by reference.

Examples of DMC catalysts that can be prepared include zinc hexacyanocobaltate(II), zinc hexacyanoferrate (III), zinc hexacyanoferrate (II), nickel(II) hexacyanoferrate(II) and cobalt(II) hezxacyanocobaltate(III). Further examples are listed in U.S. Pat. No. 5,158,922, which is herewith incorporated by reference.

Preferably the DMC catalyst is a zinc hexacyanocobaltate, preferably complexed with a water soluble aliphatic alcohol, most preferably completed with tert-butyl alcohol.

In step b) of the process according to the invention the catalyst of step a) is dispersed in a dispersing agent.

As a dispersion agent a wide range of compounds can be used. Preferably, however the dispersion agent is a low molecular weight compound, having a molecular weight in the range from 50 to 1000, more preferably in the range from 100 to 800. Preferred dispersion agents include polyols such as polypropylene glycol. Especially preferred is a polypropylene glycol having a molecular weight in the range from 200 to 700.

The dispersion can be prepared by simply mixing of the DMC catalyst and the dispersion agent, possibly with assistance of a mechanical or magnetic stirrer.

By sedimentation is understood settling of the particles under gravity or centrifugal force. Sedimentation can be achieved by allowing the catalyst dispersion to stand over a period of time. Preferably the catalyst dispersion is allowed to settle for a period in the range from 1 to 72 hours, more preferably for a period in the range from 3 to 48 hours and most preferably for a period in the range from 7 to 24 hours.

Hereafter dispersed catalyst can be separated from sedimentated catalyst. Preferably at least 1% by weight of the total amount of catalyst present is sedimentated, more preferably at least 5% by weight and most preferably at least 10% by weight. Preferably at most 70% by weight of the total amount of catalyst present is sedimentated, more preferably at most 50% by weight and most preferably at most 30% by weight. Preferably only part of the dispersed catalyst is used in any further steps, such as for example the preparation of polyether polyols. Preferably at most 80% by volume of the total volume of dispersed catalyst, more preferably at most 70% by volume and most preferably at most 50% by volume. Preferably at least 1% by volume, more preferably at least 3% by volume and most preferably at least 5% by volume is used.

According to the present invention the particle size of such a DMC catalyst is reduced to obtain a double metal cyanide (DMC) catalyst having a particle size distribution wherein 95 volume % or more of the particles have a particle size smaller than 50 micron.

Preferably the catalyst particle size is reduced to obtain a particle size distribution wherein 98 volume % or more of the particles have a particle size smaller than 50 micron, and more preferably the catalysts has a particle size distribution wherein 99 volume % or more of the particles have a particle size smaller than 50 micron. Most preferably essentially 100% of the particles have a particle size smaller than 50 micron.

In a further preferred embodiment the catalyst particle size is reduced to obtain a particle size distribution wherein 95 volume % or more of the particles have a particle size smaller than 40 micron. More preferably the catalyst has a particle size distribution wherein 98 volume % or more of the particles have a particle size smaller than 40 micron, and more preferably the catalysts has a particle size distribution wherein 99 volume % or more of the particles have a particle size smaller than 40 micron. Most preferably essentially 100% of the particles have a particle size smaller than 40 micron.

In another preferred embodiment the catalyst particle size is reduced to obtain a particle size distribution wherein 85 volume % or more of the particles have a particle size smaller than 20, preferably 19 micron More preferably the catalyst has a particle size distribution wherein 90 volume % or more of the particles have a particle size smaller than 20, preferably 19 micron, and more preferably the catalysts has a particle size distribution wherein 95 volume % or more of the particles have a particle size smaller than 20, preferably 19 micron.

In a still further preferred embodiment the catalyst particle size is reduced to obtain a particle size distribution wherein 60 volume % or more of the particles have a particle size smaller than 10 micron. More preferably the catalyst has a particle size distribution wherein 70 volume % or more of the particles have a particle size smaller than 10 micron.

By mean particle size, also sometimes called Mass Median Diameter (MMD), is understood the particle size at which 50% of the total amount of particles has a particle size below this value. The mean particle size of the catalyst particles preferably lies in the range from 2 to 20 micron. More preferably the mean particle size is less than 15 micron and even more preferably less than 10 micron. Even more preferably the mean particle size is less than 7.5 micron. In a further preferred embodiment the mean particle size is at least 3 micron. Most preferably the mean particle size of the catalyst particles lies in the range from 3 to 7.5 micron.

The catalyst can be mainly crystalline or mainly amorphous. Examples of a crystalline catalyst include the catalysts described in EP-A-1257591, EP-B-1259560 and WO-A-99/44739. Preferably, however, a DMC catalyst is used which comprises i) up to 10 wt. % of crystalline DMC component and ii) at least 90 wt. % of a DMC component which is amorphous to X-rays. More preferably a DMC, a DMC catalyst is used which comprises at least 99 wt. % of a DMC component, which is amorphous to X-rays. By amorphous is understood lacking a well-defined crystal structure or characterised by the substantial absence of sharp lines in the X-ray diffraction pattern. The process of the present invention advantageously allows one to reduce the particle size of a DMC catalyst whilst the amorphous or crystalline structure of such DMC catalyst is maintained.

Powder X-ray diffraction (XRD) patterns of conventional double metal cyanide catalysts show characteristic sharp lines that correspond to the presence of a substantial proportion of a highly crystalline DMC component. Highly crystalline zinc hexacyanocobaltate prepared in the absence of an organic complexing agent, which does not actively polymerize epoxides, shows a characteristic XRD fingerprint of sharp lines at d-spacings of about 5.07, 3.59, 2.54, and 2.28 angstroms. One of the preferred DMC catalysts is a catalyst according to EP-A-654302.

The catalysts described herein can advantageously be used for polymerization of alkylene oxides, which polymerization comprises polymerising an alkylene oxide in the presence of a DMC catalyst. Such a polymerization can for example be carried out as described in EP-A-654302, WO-01/72418 and EP-A-1257591, EP-B-1259560 and WO-A-99/44739.

Herein below the invention will be illustrated by the following examples.

### Example on the Catalyst Preparation

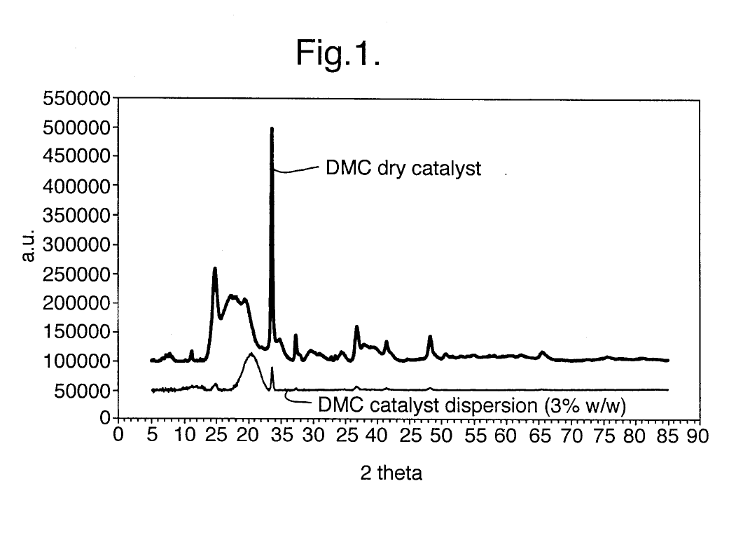

15 grams of a catalyst comprising zinc hexacyanocobaltate complexed with tert-butyl alcohol and polypropylene with a molecular weight of 2000, having the characteristics as listed in table 1 and, was dispersed in 485 grams of polypropylene glycol with a Mw of 400 at a temperature of 40° C. to prepare a 3% w/w catalyst dispersion (dispersion of catalyst A). The zinc and cobalt concentration of the catalyst was determined beforehand by Inductive Coupled Plasma (ICP) whilst using a mixture of 94% v/v isopropyl alcohol, 5% v/v water and 1% v/v HNO₃. The results are listed in table 1. In addition X-ray diffraction was used to determine the structure of the catalyst. The X-ray diffraction spectrum is enclosed as FIG. 1.

10 ml of catalyst dispersion A was allowed to stand in a 10 ml flask for 16 hours. Hereafter part of the catalyst had formed a sediment on the bottom of the flask. From the top layer of the dispersion in the flask 0.8 ml was taken (dispersion of catalyst B).

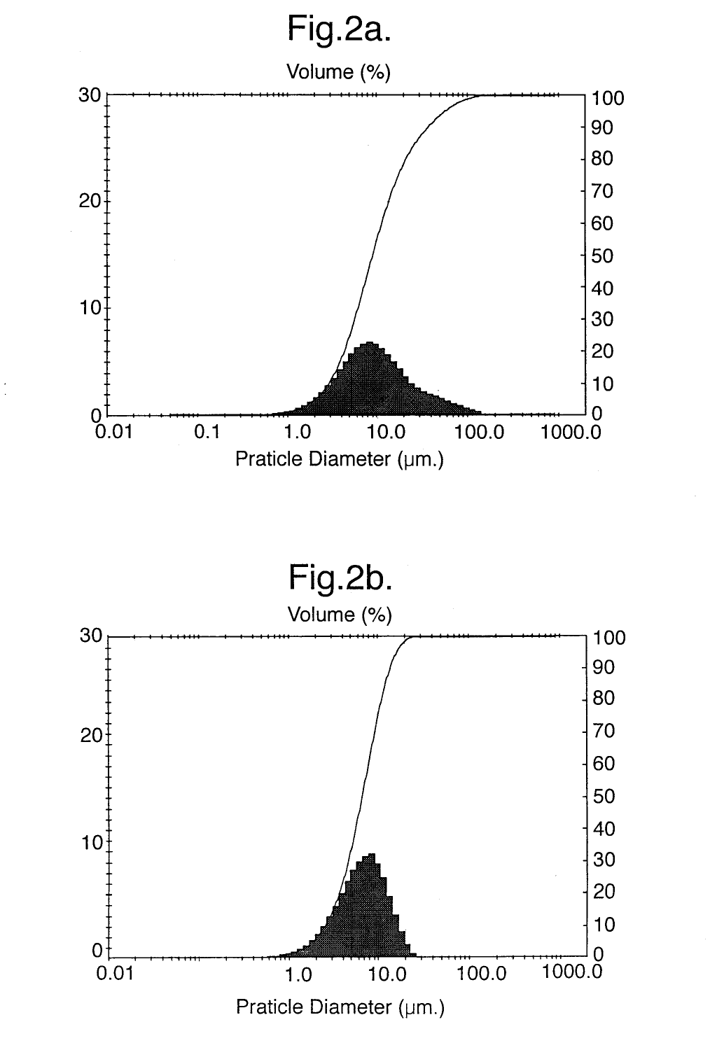

It was found that catalyst B had a different mean particle size and particle size distribution than catalyst A. The mean particle size and particle size distribution for both catalyst A as well as catalyst B are given in table 2. The particle size distribution is further illustrated in respectively FIG. 2a and FIG. 2b.

The particle size distribution (PSD) of the catalyst is measured using a MasterSizer S analyser from Malvern/Goffin Meyvis with software version 2.17. The MasterSizer S has a 2 milliwatts He—Ne laser which is used at a wavelength of 632.8 nm. A 300 RF mm lens is used giving a PSD range of 0.05-878.67 μm. The active beam length is 2.4 mm. The analysis is using the Laserdiffraction principles based on the Mie theory. For the Mie theory it is necessary to know the Refraction Index (Ri) of the catalyst particles and the dispersant as well the absorption of the particles is needed. For the analysis of the DMC catalyst the following Ri and absorption values were used:

### Particles Ri=2.5935, abs. 3.00

### Dispersant Ri=1.3300

Part of the catalyst dispersion is brought into a dispersion unit filled with Ethanol 96% denaturated with 5% Methanol until an obscuration of 10-15% is reached. The dispersion unit is connected to the measurement cell. One measurement is done by performing a total of 10000 Sampling Sweeps. All 45 data channels of the apparatus were used.

In view of their small size, the particles are assumed to be round for the above measurements and the generated values are assumed to be values of the diameter of the particles.

TABLE 1
Characteristics of the hexacyanocobaltate
catalyst

| | |
|---|---|
| Zinc concentration % w/w | 25.3 |
| Cobalt concentration % w/w | 10.9 |
| Zinc/Cobalt ratio w/w | 2.32 |

TABLE 2
Particle size distribution for catalyst A and B

| | mean | | | | | |
|---|---|---|---|---|---|---|
| | particle | | | | | |
| | size of | | | | | |
| | the | Volume % of particle size | | | | |
| | catalyst | <10.8 | <19.4 | <31.7 | <38.5 | <51.6 |
| Catalyst | (micron) | micron | micron | micron | micron | micron |
| A | 9.0 | 57.8 | 78.1 | 87.7 | 90.5 | 94 |
| B | 6.6 | 80 | 98.3 | 100 | 100 | 100 |

### COMPARATIVE EXAMPLES 1-4 AND EXAMPLE 5

A 1.25 liter stirred tank reactor was charged with a suspension of 89 g of propoxylated glycerol having an average molecular weight of 670 and an amount of catalyst dispersion A or B as indicated in table 3.

The reactor was heated to 130° C. at a pressure of 0.1 bara or less with a small nitrogen purge. The reactor was evacuated and propylene oxide was added at a rate of 3.25 grams per minute until the pressure reached 1.3 bara. As soon as the reaction of propylene oxide made the pressure drop to less than 0.8 bara, the addition of propylene oxide was started again and was continued such that the pressure was kept between 0.6 and 0.8 bara.

After 311 g of propylene oxide were added, a polyether polyol having a molecular weight of 3000 was obtained and the addition of glycerine was started at a rate of 0.1 grams per minute. The addition was stopped when 698.7 g of propylene oxide and 12.3 g of glycerine had been added. The difference between the pressure during addition of propylene oxide and the pressure when the addition of propylene oxide had been stopped, was determined. This pressure difference is a measure for the activity of the catalyst. A lower pressure difference represents a more active catalyst.

In table 3 the results are given.

TABLE 3
Pressure difference obtained for certain
concentration of catalyst.

| | catalyst | PO difference | Concentration w/w of |
|---|---|---|---|
| | dispersion | in pressure | catalyst in end- |
| | added (gram) | (bar) | product (ppmw) |
| 1 | 0.36 of disp. | 0.4 | 14.2 |
| | cat. A | | |
| 2 | 0.6 of disp. | 0.26 | 23.6 |
| | cat. A | | |
| 3 | 0.36 of disp. | 0.37 | 14.4 |
| | cat. A | | |
| 4 | 0.6 of disp. | 0.27 | 22.2 |
| | cat. A | | |
| 5 | 0.8 of disp. | 0.27 | 17.4 |
| | cat. B | | |

Although the concentration of the catalyst is less for experiment 5, the PO difference was just as low as that of comparative experiment 4. From the above it can thus be concluded that the catalyst of example 5 is more active.

1. A process for the preparation of a double metal cyanide (DMC) catalyst comprising
a) preparing a DMC catalyst;
b) dispersing the catalyst of step a) in a dispersion agent, yielding a catalyst dispersion;
c) allowing sedimentation of part of the catalyst from the catalyst dispersion obtained in step b), yielding a sedimentated catalyst and a dispersed catalyst; and
d) separating the dispersed catalyst from the sedimentated catalyst.

2. The process according to claim 1, wherein in steps b), c) and d) the particle size of the DMC catalyst is reduced to obtain a particle size distribution wherein 95 volume % or more of the particles have a particle size smaller than 50 micron,

3. The process according to claim 1, wherein in steps b), c) and d) the particle size of the DMC catalyst is reduced to obtain a particle size distribution wherein 80 volume % or more of the particles have a particle size smaller than 20 micron.

4. The process according to claim 1, wherein the particle size of the DMC catalyst is reduced to obtain a mean particle size in the range from 2 to 20 micron.

5. The process according to claim 1, wherein the DMC catalyst comprises i) up to 10 wt. % of crystalline DMC component and ii) at least 90 wt. % of a DMC component which is amorphous to X-rays.

6. The process according to claim 1, wherein the DMC catalyst is a zinc hexacyanocobaltate.

7. The process according to claim 1, wherein the catalyst dispersion obtained in step b) is allowed to stand over a period of time in the range from 1 to 72 hours in step c).

8. The process according to claim 1, wherein step a) comprises the steps of
i) combining an aqueous solution of a metal salt with an aqueous solution of a metal cyanide salt and reacting these solutions wherein at least part of this reaction takes place in the presence of an organic complexing agent, thereby forming a dispersion of a solid DMC complex in an aqueous medium;
ii) combining the dispersion obtained in step (i) with a liquid, which is essentially insoluble in water and which is capable of extracting the solid DMC complex allowing a two-phase system to be formed consisting of a first aqueous layer and a layer containing the DMC complex and the liquid added;
iii) removing the first aqueous layer; and
iv) recovering the DMC catalyst from the layer containing the DMC catalyst.

9. The process according to claim 1, wherein step a) comprises the steps of
i) intimately combining and reacting an aqueous solution of a water-soluble metal salt and an aqueous solution of a water-soluble metal cyanide salt in the present of an organic complexing agent, to obtain an aqueous mixture that contains a precipitated DMC catalyst;
ii) isolating and drying the catalyst obtained in step i).

10. A catalyst obtained by the process for the preparation of a double metal cyanide (DMC) catalyst comprising
a) preparing a DMC catalyst;
b) dispersing the catalyst of step a) in a dispersion agent, yielding a catalyst dispersion;
c) allowing sedimentation of part of the catalyst from the catalyst dispersion obtained in step b), yielding a sedimentated catalyst and a dispersed catalyst; and
d) separating the dispersed catalyst from the sedimentated catalyst.

11. A process for polymerization of alkylene oxides, which process comprises polymerising an alkylene oxide in the presence of a DMC catalyst as claimed in claim 10.
